(19) United States
(12) Patent Application Publication
(10) Pub. No.: US 2010/0053761 A1
(43) Pub. Date: Mar. 4, 2010

(54) HYBRID OPTICAL FILM, DISPLAY DEVICE HAVING THE SAME, AND METHOD OF MANUFACTURING THE SAME

(75) Inventors: Ji Yoon YEOM, ChungCheongNam-Do (KR); Sung Nim Jo, ChungCheongNam-Do (KR); Eun Young Cho, ChungCheongNam-Do (KR); Hyun Sook Kim, ChungCheongNam-Do (KR); Joo Sok Kim, ChungCheongNam-Do (KR)

Correspondence Address: MCDERMOTT WILL & EMERY LLP, 600 13TH STREET, N.W., WASHINGTON, DC, 20005-3096, US

(73) Assignee: SAMSUNG CORNING PRECISION GLASS CO., LTD.

(21) Appl. No.: 12/549,700

(22) Filed: Aug. 28, 2009

(30) Foreign Application Priority Data
Aug. 29, 2008 (KR) 10-2008-0085218
Feb. 4, 2009 (KR) 10-2009-0008926

(51) Int. Cl. G02B 1/10; G02B 1/12

(52) U.S. Cl. 359/614; 359/601; 264/2.1; 264/1.36

(57) ABSTRACT

A hybrid optical film, a display device having the same, and a method of manufacturing the same are provided. The hybrid optical film is provided in front of a display module of a display device to serve as a display filter. The hybrid optical film is in the form of a single-film. The hybrid optical film includes a film substrate; a first optical pattern directly formed on one side of the film substrate; and a second optical pattern directly formed on the other side of the film substrate. The hybrid optical film can reduce manufacturing costs due to a simplified structure and improve productivity due to a simplified manufacturing process.

### CROSS-REFERENCE TO RELATED APPLICATION

This application claims the benefit of Korean Patent Application Nos. 10-2008-0085218 and 10-2009-0008926 filed on Aug. 29, 2008 and Feb. 4, 2009, respectively, in the Korean Intellectual Property Office, the disclosure of which is incorporated herein by reference.

### BACKGROUND OF THE INVENTION

1. Field of the Invention

The present invention relates to an optical film provided in front of a display module, and more particularly, to a hybrid optical film, which can reduce manufacturing costs due to a simplified structure and improve productivity due to a simplified manufacturing process, a display device having the same, and a method of manufacturing the same.

2. Description of Related Art

In response to late emergence of high-level information society, components and devices related to image displays are being significantly advanced and rapidly distributed. Among them, image-displaying devices to be used for televisions, monitors of personal computers, etc. are being widely distributed. In addition, there are attempts to enlarge the size while reducing the thickness of the display devices.

In general, a Plasma Display Panel (PDP) is gaining popularity as a next-generation display since it can have a large size and a thin profile compared to a Cathode Ray Tube representing conventional display devices. The PDP displays an image using gas discharge, and has excellent display properties in terms of display capability, luminance, contrast, after-image characteristics, and viewing angle. The PDP, as a thin light-emitting display device, can increase its size more easily compared to other display devices, and is regarded as having most suitable characteristics for a future high-quality digital television. Accordingly, the PDP is highly evaluated as the next-generation display device that can replace the CRT.

In the PDP, a direct or alternating voltage is applied to electrodes in cells full of gas, which generates ultraviolet (UV) radiation. The UV radiation in turn activates phosphor to thereby emit visible light. However, as drawbacks, the PDP emits Electro-Magnetic Interference (EMI) harmful to the human, Near Infrared Rays (NIR) that may cause a remote controller and the like to malfunction, and orange light deteriorating color purity.

Accordingly, in order to block EMI and NIR, to improve color purity, and furthermore, to decrease light reflection, the PDP is using a functional PDP filter, which has EMI shielding, color correction, and/or anti-reflection functions.

A conventional PDP filter is fabricated by bonding a plurality of films to a transparent substrate using adhesive. The films generally include an external light blocking film, a color-correcting film, etc.

Since a plurality of the films having their own functions are bonded to the transparent substrate, the number of the films increases, which acts as obstacles in the way of decreasing weight and thickness and thus increases fabrication costs. In addition, since the PDP filter requires a plurality of bonding processes due to a plurality of the films, a fabrication process is complicated, thereby deteriorating productivity. Furthermore, the increase in the number of the films and bonding layers leads to the decrease in transmittance, thereby deteriorating the quality of the display device.

### BRIEF SUMMARY OF THE INVENTION

One object of the present invention is to provide a hybrid optical film, which can realize a light and thin structure and reduce manufacturing costs due to a simplified structure, and a method of manufacturing the same.

Another object of the present invention is to provide a hybrid optical film which can improve productivity due to a simplified manufacturing process, and a method of manufacturing the same.

Still another object of the present invention is to ensure excellent display quality by preventing transmittance degradation.

In an aspect of the present invention, the hybrid optical film is provided in front of a display module of a display device to serve as a display filter. The hybrid optical film is in the form of a single-film, and includes a film substrate; a first optical pattern directly formed on one side of the film substrate; and a second optical pattern directly formed on the other side of the film substrate.

Each of the first and second optical patterns may include one selected from the group consisting of an external light-shielding pattern which is filled with a light absorbing material, an electromagnetic-shielding conductive mesh pattern which is filled with a conductive material, and an anti-glare protrusion-depression pattern.

In another aspect of the present invention, the method of manufacturing a hybrid optical film, which is provided in front of a display module to serve as a display filter, includes forming first and second optical patterns on a film substrate such that the first optical pattern is directly formed on one side of the film substrate and the second optical pattern is directly formed on the other side of the film substrate.

The steps of forming the first and second optical patterns may include forming depressions on the film substrate; and filling the depression with a light absorbing material or a conductive material.

According to exemplary embodiments of the present invention as set forth above, the hybrid optical film in the form of the single film can advantageously reduce weight and thickness and save manufacturing costs.

Since the functional optical patterns are formed on both sides of the film substrate by one process, a manufacturing process can be simplified thereby improving productivity. Compared to a complicated conventional process in which a plurality of films are separately prepared and then are bonded to each other, the invention can greatly simplify the manufacturing process and significantly improve productivity.

In particular, when a roll-to-roll process, preferably, a roll-to-roll process with a single continuous flow is used, the manufacturing process can be innovatively improved and simplified, thereby further reducing manufacturing costs and improving productivity.

Furthermore, when a color-correcting colorant and/or an NIR-absorbing material are added to a transparent polymer resin forming the film substrate, or to an adhesive, it is possible to further reduce manufacturing costs and improve productivity.

Moreover, since the hybrid optical film is in the form of the single film, it is possible to prevent transmittance degradation, thereby ensuring excellent display qualities.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating a hybrid optical film according to a first exemplary embodiment of the invention;

FIG. 2 is a cross-sectional view illustrating a hybrid optical film according to a second exemplary embodiment of the invention;

FIG. 3 is a schematic view illustrating a process of manufacturing the hybrid optical film shown in FIG. 2;

FIG. 4 is a perspective view illustrating a hybrid optical film according to a third exemplary embodiment of the invention;

FIG. 5 is a plan view illustrating a conductive mesh pattern of the hybrid optical film shown in FIG. 4;

FIG. 6 is a perspective view illustrating a process of manufacturing the hybrid optical film shown in FIG. 4; and

FIG. 7 is an exploded perspective view illustrating a display device according to a fourth embodiment of the invention.

### DETAILED DESCRIPTION OF THE INVENTION

Reference will now be made in detail to various embodiments of the present invention, examples of which are illustrated in the accompanying drawings and described below.

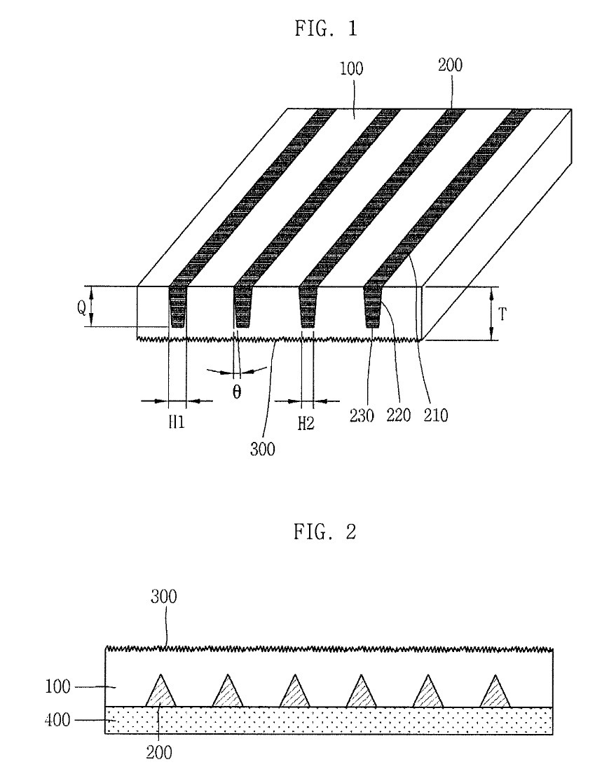

FIG. 1 is a perspective view illustrating a hybrid optical film according to a first exemplary embodiment of the invention.

The hybrid optical film of this embodiment is provided in front of a display module of a display device. The hybrid film serves as a display filter.

As shown in the figure, the hybrid optical film of this embodiment is in the form of a single film. The term “is in the form of a single film” does not exclude an adhesive applied on the surface of a film substrate as shown in FIG. 2, or a functional film adhered to the hybrid optical film of this embodiment. For example, a functional film such as an Anti-Reflection (AR) film or an anti-fog film can be adhered to the hybrid optical film of this embodiment. Furthermore, even if the hybrid optical film is illustrated as having, for example, an external light-shielding pattern, a conductive mesh pattern, or a protrusion-depression pattern, it should not be understood as excluding, for example, an external light-shielding film, an electromagnetic shielding film, or an anti-glare film adhered to the hybrid optical film in order to more enhance functionality.

The hybrid optical film includes a film substrate and first and second optical patterns. The first optical pattern is directly formed on one side of the film substrate, and the second optical pattern is directly formed on the other side of the film substrate.

FIG. 1 shows the exemplary embodiment in which the first optical pattern is an external light-shielding pattern 200 and the second optical pattern is an anti-glare protrusion-depression pattern 300.

The external light-shielding pattern 200 is filled with a light-absorbing material to absorb light entering from the outside towards the display module. The external light-shielding pattern 200 can have a variety of shapes as long as it can be provided on the film substrate at a predetermined depth to thereby block external light entering from the outside. Examples of the external light-shielding pattern may include, but not limited to, stripes with a wedge-shaped cross section, waves with a wedge-shaped cross section, a matrix with a wedge-shaped cross section, a honeycomb with a wedge-shaped cross section, stripes with a quadrangular cross section, waves with a quadrangular cross section, a matrix with a quadrangular cross section, and a honeycomb with a quadrangular cross section. Referring to FIGS. 1 and 2, the external light-shielding pattern is stripes with a wedge-shaped cross section.

The film substrate 100 is typically made of transparent polymer resin. The film substrate can be made of any types of highly-transparent material that allows the optical pattern to be formed thereon. Examples of the material can include polyesters, acryls, celluloses, polyolefins, polyvinyl chlorides, polycarbonates, phenols, urethanes, etc.

The film substrate can contain a color-correcting colorant, a Near Infrared Ray (NIR) absorbing material, etc. These materials can replace an additional color correction film and/or a NIR shielding film, thereby reducing manufacturing costs while improving both productivity and transmittance.

The color-correcting colorant absorbs a specific wavelength of visible light. The color-correcting colorant includes a toning colorant and/or a neon-cutting colorant.

The toning colorant performs a color-toning function by changing or adjusting color balance by changing or adjusting the amount of red, green, and/or blue.

In general, a Plasma Display Panel (PDP) emits neon light, which leads to a degradation in color purity. Therefore, the neon-cutting colorant may be used to absorb the orange neon light the wavelength of which is in the range from 580 nm to 600 nm.

Various types of the color-correcting colorant can be used in order to increase the range of color reproduction as well as to increase definition. The colorant can be dye or pigment, examples of which may include, but not limited to, cyanines, anthraquinones, naphthoquinones, phthalocyanines, dimoniums, nickel (Ni) dithiols, azos, styryls, methines, porphyrins, azaporphyrins, etc. The types and concentrations of the colorant are not limited to specific values since they are determined by the absorption wavelength and coefficient of the colorant and transmission characteristics required in the display device.

The NIR-absorbing material absorbs NIR wavelength light. The NIR-absorbing material available in this embodiment is not specifically limited, but can be at least one selected from the group consisting of mixed colorants of nickel complex and diammonium; compound colorants containing copper (Cu) ions and zinc (Zn) ions; cyanine-based colorants; anthraquinone-based colorants; and squarilium-, azomethine-, oxonol-, azo-, or benzylidene-based compounds.

In the hybrid optical film of this embodiment, the NIR transmittance can preferably be 10% or less. In particular, at a wavelength of 850 nm, the NIR transmittance can preferably satisfy this value. If the NIR transmittance exceeds 10%, the possibility sharply increases that a remote controller and/or a precision device are subject to malfunction due to the NIR.

The film substrate 100 can also contain an ultraviolet (UV) absorbent. The UV absorbent can be an organic or inorganic UV absorbent. The organic UV absorbent can be more preferable in terms of transparency. Any known organic UV absorbents can be used as the organic UV absorbent of this embodiment. Among the known organic UV absorbents, benzotriazole, benzophenone, and annular iminoester can be preferably used. In particular, annular iminoester is more preferable in terms of heat resistance. In addition, two or more types of the UV absorbents can be used in combination.

The external light-shielding pattern 200 is generally provided on the backside of the film substrate 100 with the bottom of the wedge shape facing the display module. However, the present invention is not limited to this configuration. In the external light-shielding pattern 200 shown FIG. 1, stripes of the pattern are arranged parallel to each other and are spaced apart from each other at regular intervals.

The external light-shielding pattern 200 is filled with a light-absorbing material. Examples of the light-absorbing material may include black inorganic materials, organic materials, metals, etc., which can absorb light. The light-absorbing material can preferably be carbon black. In case metal powder is added in the external light-shielding pattern 200, it can function as an electromagnetic shield. Electric resistance can be adjusted depending on the concentration of the metal powder. For this, a black metal, a metal the surface of which is blackened, or a black light-absorbing material into which a metal is mixed can be used.

The external light-shielding pattern 200 may be filled with a UV curing resin in addition to the light-absorbing material.

In the external light-shielding pattern 200, light-shielding effect, transmittance, and a viewing angle are determined by a pitch P, a depth Q, a greater width H1, a smaller width H2, and an angle of inclination θ. The difference between the refractive index of the external light-shielding pattern and the refractive index of the film substrate can be preferably 0.05 or less. The external light-shielding pattern 200 can be arranged in the horizontal or vertical direction with respect to a viewer of the display device.

The protrusion-depression pattern 300 serves to reduce light reflection while removing moires. FIG. 1 shows the embodiment in which the protrusion-depression pattern 300 is a roughness pattern. However, the protrusion-depression pattern can have various other shapes, such as an embossing pattern, as long as they can achieve an anti-glare effect.

FIG. 2 is a cross-sectional view illustrating a hybrid optical film according to a second exemplary embodiment of the invention.

The hybrid optical film of this embodiment is configured in such a manner that an adhesive 400 is applied on at least one side of the film substrate.

Specifically, the adhesive 400 is applied on one side and/or the other side of the film substrate 100. Thereby, another functional film can be additionally bonded to the hybrid optical film of this embodiment, the film substrate 100 can be bonded to a display module, or a transparent substrate can be bonded to the film substrate 100 to enhance the strength of the hybrid film.

Specific examples of the adhesive 400 may include acrylic adhesive, silicon-based adhesive, urethane-based adhesive, polyvinylbutyral (PMB) adhesive, ethylene-acetate adhesive, polyvinyl ether, saturated amorphous polyester, melamine resin, etc.

The adhesive 400 can contain, for example, a color-correcting colorant and/or an INR-absorbing material.

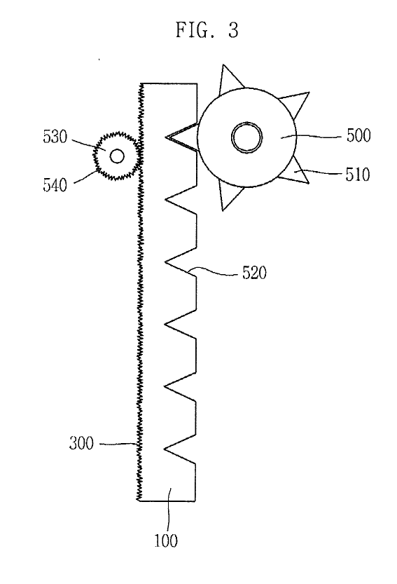

FIG. 3 is a schematic view illustrating a process of manufacturing the hybrid optical film shown in FIG. 2.

The hybrid optical film can be manufactured by the following process.

First, a film substrate 100 is formed. Specifically, the film substrate 100 is formed, for example by extrusion, in the form of a film having a predetermined thickness. However, the forming process is not limited to the extrusion but can use a variety of processes such as injection molding. In this process, a color-correcting colorant and/or a NIR-absorbing colorant may be mixed into a transparent polymer resin, and then the mixture is extruded. In one embodiment, depressions can be formed during the extrusion using an extrusion die having, for example, protrusions thereon.

Due to the extrusion cooperating with the following roll-forming process, the process of manufacturing the hybrid optical film of the invention can be carried out as a continuous process. Specifically, the extruded film substrate is molded while being conveyed downstream by a forming roll so that the manufacturing process can be accomplished in one continuous conveying flow. This, as a result, can innovatively promote and simplify the manufacturing process, thereby greatly improving productivity.

A first forming roll 500 forms wedge-shaped depressions 520 at regular intervals in one side of the extruded film substrate 100, and a second forming roll 530 forms a protrusion-depression pattern 300 on the other side of the film substrate 100. The first forming roll 500 has protrusions 510, on the outer circumferential surface thereof, opposite to the depressions 520. The second forming roll 530 has an outer-circumferential pattern opposite to the protrusion-depression pattern 300 to be formed on the film substrate 100.

As the first forming roll 500 is pressed onto the one side of the film substrate 100, a first outer-circumferential pattern of the first forming roll 500 is transferred to the one side of the film substrate 100. Thereby, the depressions 520 which are opposite to the protrusions 510 on the outer circumferential surface of the first forming roll 500 are formed in the one side of the substrate 100.

As the second forming roll 530 is pressed onto the other side of the film substrate 100, the second outer-circumferential pattern 540 of the second forming roll 530 is transferred to the other side of the film substrate 100. Thereby, the protrusion-depression pattern 300 which is opposite to the second outer-circumferential pattern 540 is formed on the other side of the film substrate 100.

The first and second forming rolls 500 and 530 may be arranged facing each other such that the depressions 520 and the protrusion-depression pattern 300 can be formed, at the same time, on the one side and on the other side of the film substrate 100, respectively, while the film substrate 100 is being conveyed through the space between the two forming rolls 500 and 530.

Afterwards, a UV curing resin into which a light-absorbing material is mixed, is provided into the depressions 520, and then is UV-irradiated, thereby forming the external light-shielding pattern 200 (see FIGS. 1 and 2).

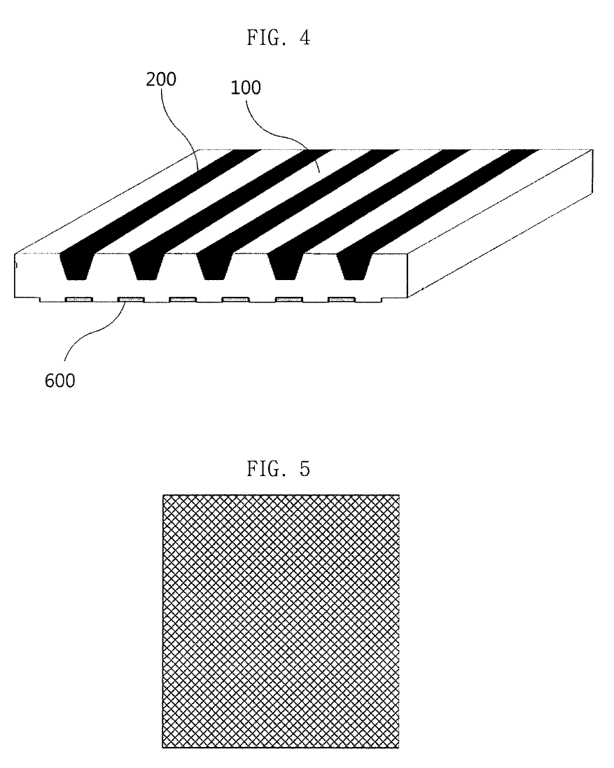

FIG. 4 is a perspective view illustrating a hybrid optical film according to a third exemplary embodiment of the invention.

As shown in FIG. 4, the hybrid optical film includes an external light-shielding pattern 200 as a first optical pattern and a conductive mesh pattern 600 as a second optical pattern. The conductive mesh pattern 600 is more specifically illustrated referring to FIG. 5. The conductive mesh pattern 600 is filled with a conductive material to thereby block Electro-Magnetic Interference (EMI).

Examples of the conductive material may include Cu, Cr, Ni, Ag, Mo, W, Al, etc., which have excellent electric conductivity.

The conductive mesh pattern 600 is grounded to, for example, a case, such that EMI trapped in the conductive mesh pattern can be emitted towards the case without reaching a viewer of the display device.

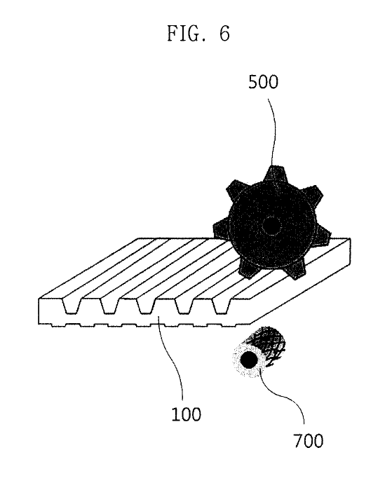

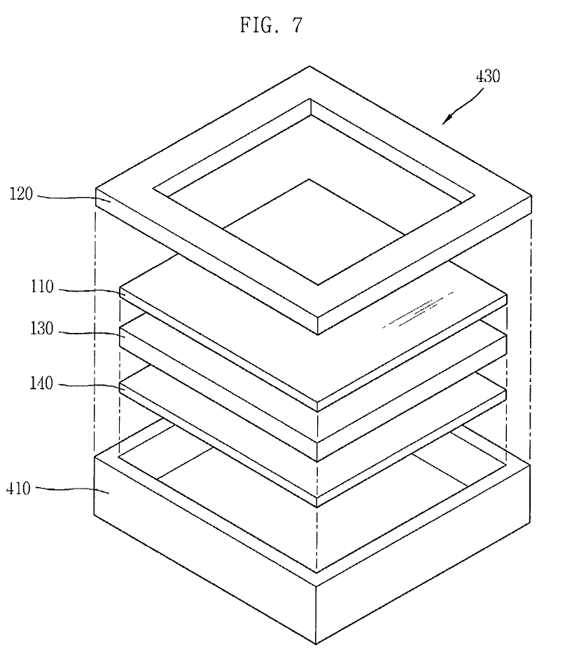

FIG. 6 is a perspective view illustrating a process of manufacturing the hybrid optical film shown in FIG. 4.

As shown in the figure, both a first forming roll 500 and a second forming roll 700 have protrusions on the outer circumferential surfaces thereof. A film substrate 100 is brought into contact with the first and second forming rolls 500 and 700 so that depressions are formed in both sides of the film substrate 100. Then, a light-absorbing material is provided into the depressions in one side of the film substrate, and a conductive material is provided into the depressions in the other side of the film substrate.

Although both the external light-shielding pattern and the conductive mesh pattern are formed by a molding process in the foregoing first through third embodiments, the present invention is not limited thereto. For example, the optical pattern can be formed by printing with a light-absorbing material or a conductive material. In this case, the optical pattern can be continuously printed using a printing roll.

In the foregoing first through third embodiments, the external light-shielding pattern 200 and the protrusion-depression pattern 300 or the external light-shielding pattern 200 and the conductive mesh pattern 600 are formed on both sides of the film substrate, respectively, but the present invention is not limited thereto. For example, the protrusion-depression pattern and the conductive mesh pattern can be formed on both sides of the film substrate.

FIG. 7 is an exploded perspective view illustrating a display device according to a fourth embodiment of the invention.

As shown in FIG. 7, the display device 430 includes a case 410, a cover 120 covering the case 410, a drive circuit board 140 housed inside the case 410, a display module 130 displaying an image having discharge cells therein which is filled with gas, and a display filter 110.

The display filter may include only the hybrid optical film as described above, or include another functional film as well as the hybrid optical film.

Although the hybrid optical film of the foregoing embodiments has been illustrated as being applied to the PDP for the sake of explanation convenience, the present invention is not limited thereto. For example, the hybrid optical film of the invention can be used for various other image display devices such as a Liquid Crystal Display (LCD), an Electro Luminescent Display (ELD), a Vacuum Fluorescent Display (VFD), etc. as well as the PDP.

While the present invention has been shown and described with reference to exemplary embodiments thereof, it will be understood by those skilled in the art that various changes in form and details may be made therein without departing from the spirit and scope of the present invention as defined by the appended claims and their equivalents.

What is claimed is:

1. A hybrid optical film provided in front of a display module of a display device to serve as a display filter,
the hybrid optical film being in the form of a single-film and comprising a film substrate; a first optical pattern directly formed on one side of the film substrate; and a second optical pattern directly formed on the other side of the film substrate.

2. The hybrid optical film in accordance with claim 1, wherein the first optical pattern comprises an external light-shielding pattern which is filled with a light-absorbing material to absorb light entering from the outside towards the display module.

3. The hybrid optical film in accordance with claim 2, wherein the external light-shielding pattern has a pattern of stripes with a wedge-shaped cross section, waves with a wedge-shaped cross section, a matrix with a wedge-shaped cross section, a honeycomb with a wedge-shaped cross section, stripes with a quadrangular cross section, waves with a quadrangular cross section, a matrix with a quadrangular cross section, or a honeycomb with a quadrangular cross section.

4. The hybrid optical film in accordance with claim 2, wherein the second optical pattern comprises a conductive mesh pattern which is filled with a conductive material.

5. The hybrid optical film in accordance with claim 2, wherein the second optical pattern comprises an anti-glare protrusion-depression pattern.

6. The hybrid optical film in accordance with claim 5, wherein the anti-glare protrusion-depression pattern comprises a roughness pattern.

7. The hybrid optical film in accordance with claim 1, wherein each of the first optical pattern and the second optical pattern comprises one selected from the group consisting of an external light-shielding pattern which is filled with a light absorbing material, a conductive mesh pattern which is filled with a conductive material, and an anti-glare protrusion-depression pattern.

8. The hybrid optical film in accordance with claim 1, wherein the film substrate contains at least one of a near infrared absorbing material and a color-correcting colorant absorbing a predetermined wavelength of visible light.

9. The hybrid optical film in accordance with claim 1, wherein an adhesive is applied on at least one of the one side and the other side of the film substrate,
the adhesive containing at least one of a near infrared absorbing material and a color-correcting colorant absorbing a predetermined wavelength of visible light.

10. A display device comprising:
a display module displaying an image; and
a hybrid optical film provided in front of the display module to serve as a display filter,
wherein the hybrid optical film is in the form of a single-film and comprises a film substrate; a first optical pattern directly formed on one side of the film substrate; and a second optical pattern directly formed on the other side of the film substrate.

11. A method of manufacturing a hybrid optical film provided in front of a display module to serve as a display filter, the method comprising:
forming a first optical pattern directly on one side of the film substrate and forming a second optical pattern directly on the other side of the film substrate.

12. The method in accordance with claim 11, wherein the step of forming the first optical pattern comprises transferring a first outer-circumferential pattern on an outer circumferential surface of a first forming roll directly onto the one side of the film substrate and
the step of forming the second optical pattern comprises transferring a second outer-circumferential pattern on an outer circumferential surface of a second forming roll directly onto the other side of the film substrate.

13. The method in accordance with claim 12, wherein
the second optical pattern comprises an anti-glare protrusion-depression pattern, and
the second outer-circumferential pattern is opposite to the anti-glare protrusion-depression pattern.

14. The method in accordance with claim 11, wherein the steps of forming the first optical pattern and the second optical pattern comprises:
forming depressions on the film substrate; and
filling the depressions with a light absorbing material or a conductive material.

15. The method in accordance with claim 14, wherein the step of forming the depressions comprises transferring protrusions onto the film substrate by bringing the film substrate into contact with a forming roll having the protrusions on an outer circumferential surface thereof, the protrusions being opposite to the depressions.

16. The method in accordance with claim 14, wherein the step of filling comprises:
filling the depressions with an ultraviolet curing resin together with the light absorbing material or the conductive material, and
curing the ultraviolet curing resin by UV irradiation.

17. The method in accordance with claim 11, wherein the step of forming the first optical pattern or the second optical pattern comprises printing the first optical pattern or the second optical pattern on the film substrate with a light absorbing material or a conductive material.

18. The method in accordance with claim 17, wherein the step of printing is performed using a printing roll.

19. The method in accordance with claim 11, further comprising forming the film substrate by extrusion before forming the first optical pattern and the second pattern on the film substrate.
